(19) United States
(12) Patent Application Publication
(10) Pub. No.: US 2021/0129241 A1
(43) Pub. Date: May 6, 2021

(54) MITER SAW

(71) Applicant: TECHTRONIC CORDLESS GP, Anderson, SC (US)

(72) Inventors: Jonathan R. Van Bergen, Easley, SC (US); Reid Cheatham, Greenville, SC (US); Tyler H. Knight, Greenville, SC (US); David E. Dutterer, Belton, SC (US)

(21) Appl. No.: 17/085,031

(22) Filed: Oct. 30, 2020

Related U.S. Application Data
(60) Provisional application No. 63/053,910, filed on Jul. 20, 2020.
(60) Provisional application No. 62/930,372, filed on Nov. 4, 2019.

(51) Int. Cl. B23D 45/04

(52) U.S. Cl. CPC B23D 45/048

(57) ABSTRACT

A miter saw includes a base assembly and a saw unit pivotably coupled to the base assembly about a first axis. The saw unit includes a saw arm, a motor supported by the saw arm, and a saw blade supported by the saw arm. The saw blade is driven by the motor to rotate about a second axis. The saw blade includes a diameter. A ratio of the diameter of the saw blade to a distance between the first and second axes is between 0.4 and 0.7.

### CROSS-REFERENCE TO RELATED APPLICATIONS

This application claims the benefit of U.S. Provisional Patent Application No. 63/053,910 filed on Jul. 20, 2020 and U.S. Provisional Patent Application No. 62/930,372 filed on Nov. 4, 2019, the contents of all of which are incorporated herein by reference.

### FIELD OF THE DISCLOSURE

The present disclosure relates to miter saws.

### BACKGROUND

Compound miter saws permit users to perform both a miter cut and a bevel cut on the same workpiece, such as crown molding. For example, a piece of crown molding may be laid flat on the worktable of a compound miter saw. Then, a compound miter/bevel cut is made to the piece of crown molding. Two pieces of crown molding are cut in this manner so that the two pieces of crown molding can abut one another along a straight-line coinciding with the corner of the room in which the crown molding is installed. Alternatively, a piece of crown molding may be oriented at an incline relative to the turntable (e.g., by 45 degrees), such that a first interior edge of the crown molding lays flat against the vertical fence and a second interior edge of the crown molding lays flat against the turntable (e.g., the crown molding is positioned on its spring angle). With the piece of crown molding oriented in this manner, a single miter cut can be made on each piece of crown molding intended to abut each other in the corner of a room.

However, cutting a piece of crown molding on its spring angle is limited by the width of the crown molding. For example, cutting a 5-inch wide piece of crown molding requires a relatively large saw blade (e.g., approximately 10 inches or more) because only one-half of the saw blade is available to plunge into the piece of crown molding. This, in turn, decreases the usefulness associated with miter saws having relatively small blade diameters (e.g., approximately 7 inches or less).

### SUMMARY

In one aspect, a miter saw includes a base assembly and a saw unit pivotably coupled to the base assembly about a first axis. The saw unit includes a saw arm, a motor supported by the saw arm, and a saw blade supported by the saw arm. The saw blade is driven by the motor to rotate about a second axis. The saw blade includes a diameter. A ratio of the diameter of the saw blade to a distance between the first and second axes is between 0.4 and 0.7.

In another aspect, a miter saw includes a base assembly and a saw unit pivotably coupled to the base assembly about a first axis. The saw unit includes a saw arm, a motor supported by the saw arm, and a saw blade supported by the saw arm. The saw blade is driven by the motor to rotate about a second axis. A line extends between the first and second axes such that a void is formed between the line and a bottom surface of the saw arm. The saw arm is configured such that a portion of a workpiece supported on the base assembly is positionable within the void during a cutting operation of the miter saw.

In yet another aspect, a miter saw includes a base assembly having a turntable, a bevel arm pivotably coupled to the turntable about a bevel axis, and a mount moveably coupled to the bevel arm between a first position, in which the mount is oriented parallel with the bevel axis, and a second position, in which the mount is oriented non-parallel with the bevel axis. The miter saw also includes a saw unit having a saw arm coupled to the bevel arm via the mount, a motor supported by the saw arm, and a saw blade supported by the saw arm. The saw blade is driven by the motor.

Other aspects of the disclosure will become apparent by consideration of the detailed description and accompanying drawings.

### BRIEF DESCRIPTION OF THE DRAWINGS

FIG. 1 is a perspective view of a miter saw according to one embodiment.

FIG. 2 is a first side view of the miter saw of FIG. 1.

FIG. 3 is a second side view of the miter saw of FIG. 1 including a saw unit in a first position relative to a base assembly of the miter saw.

FIG. 4 illustrates the saw unit of FIG. 3 in a second position relative to the base assembly of the miter saw.

FIG. 5 illustrates the saw unit of FIG. 3 in a third position relative to the base assembly of the miter saw.

FIG. 6 is a side view of the miter saw of FIG. 1 during a cutting operation on a workpiece.

FIG. 7 is a side view of a miter saw according to another embodiment including a saw unit in a first position relative to a base assembly of the miter saw.

FIG. 8 illustrates the saw unit of FIG. 7 in a second position relative to the base assembly of the miter saw.

FIG. 9 illustrates the saw unit of FIG. 7 in a third position relative to the base assembly of the miter saw.

FIG. 10 is a perspective view of a miter saw according to yet another embodiment.

FIG. 11 is a first side view of the miter saw of FIG. 10.

FIG. 12 is a second side view of the miter saw of FIG. 10 including a saw unit in a first position relative to a base assembly of the miter saw.

FIG. 13 illustrates the saw unit of FIG. 12 in a second position relative to the base assembly of the miter saw.

FIG. 14 is a first perspective view of a miter saw according to yet another embodiment including a saw unit in a first position relative to a base assembly of the miter saw.

FIG. 15 illustrates the saw unit of FIG. 14 in a second position relative to the base assembly of the miter saw.

FIG. 16 illustrates a portion of the miter saw of FIG. 14 during a cutting operation on a workpiece.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for the purpose of description and should not be regarded as limiting. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

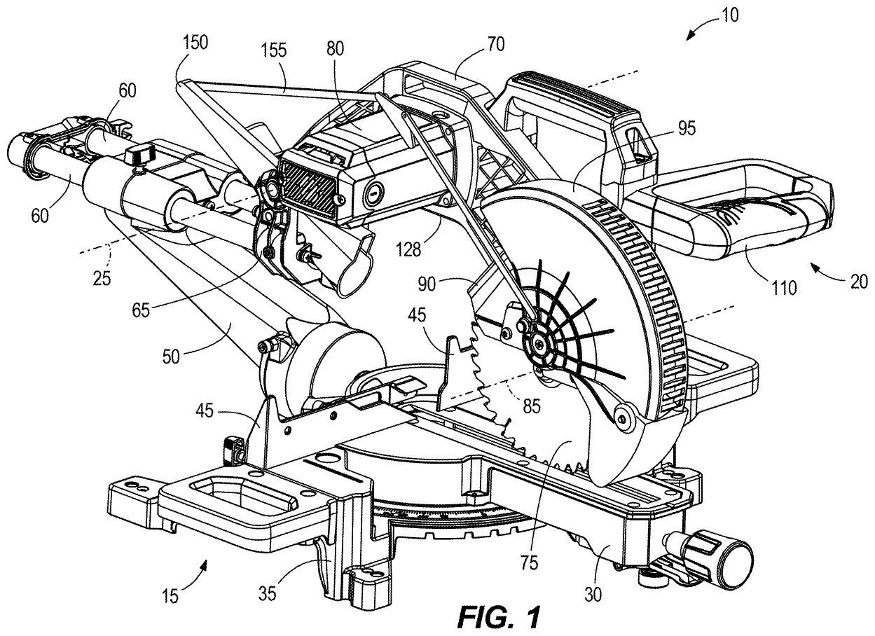

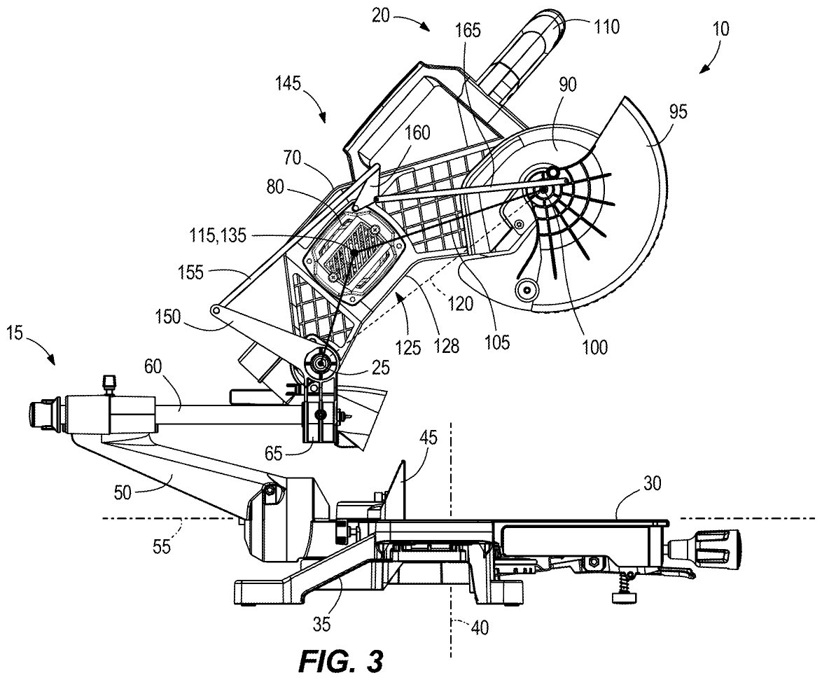

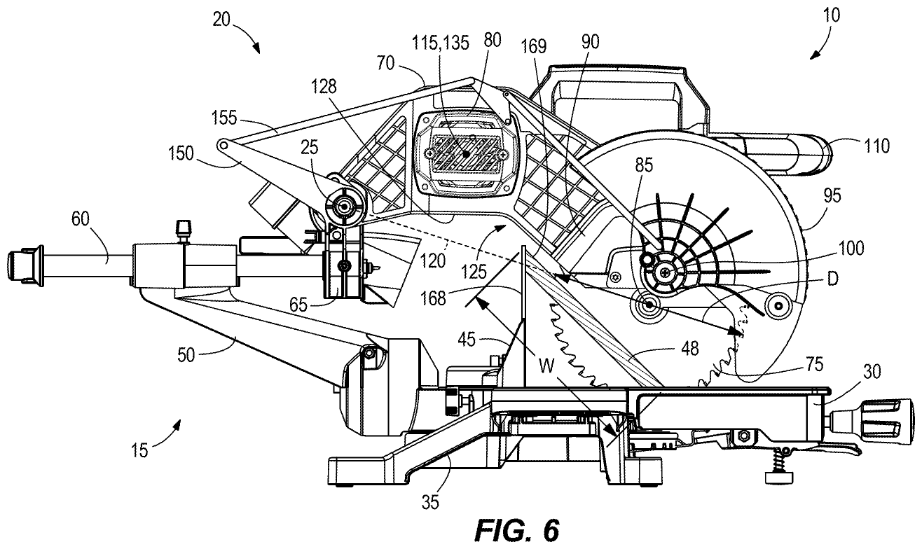

FIG. 1 illustrates a power tool (i.e., a sliding compound miter saw 10) including a base assembly 15 and a saw unit 20 pivotably coupled to the base assembly 15 about a first or chop axis 25. The illustrated base assembly 15 includes a turntable 30 pivotably coupled to a base 35 about a second or miter axis 40 (FIG. 3). The base 35 includes a fence assembly 45, and in some embodiments, the fence assembly 45 can include a first fence fixedly coupled to the base 35 and a second fence slidably coupled to the first fence. Also, in some embodiments, the base assembly 15 can include at least one support extension coupled to the base 35 (e.g., selectively coupled to the base 35, telescopically coupled to the base 35, etc.) to extend in a direction perpendicular to the miter axis 40. The support extension is configured to support a portion of a workpiece 48 (FIG. 6) if a length of the workpiece 48 extends beyond a lateral footprint of the base 35.

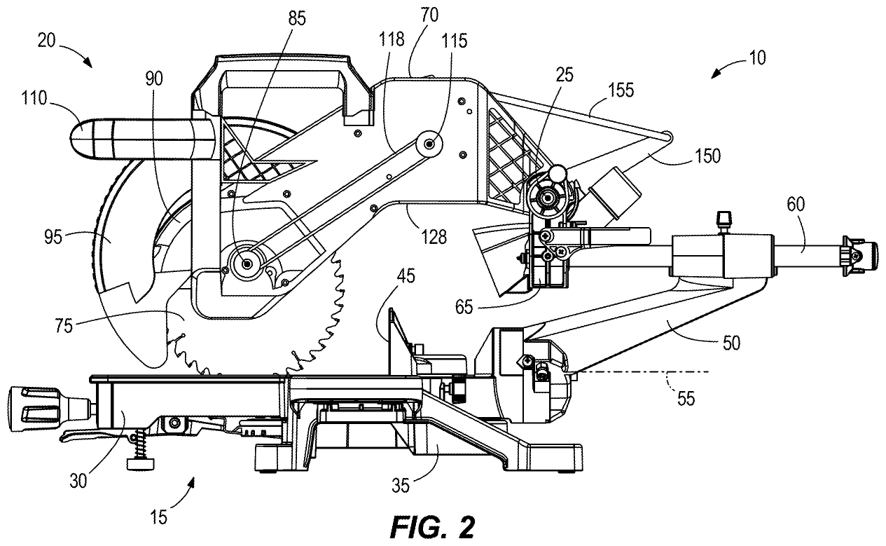

With continued reference to FIG. 1, a bevel arm 50 is pivotably coupled to the turntable 30 about a third or bevel axis 55 (FIG. 3) such that the miter saw 10 is a dual bevel miter saw. In other embodiments, the miter saw 10 can be a single bevel miter saw. Guide rails 60 are slidably coupled to the bevel arm 50 and extend parallel to the bevel axis 55. With reference to FIG. 2, the bevel arm 50 is elongated such that a length of the bevel arm 50 (in a direction parallel to the bevel axis 55) is greater than a height of the bevel arm 50 (in a direction parallel to the miter axis 40). In addition, a saw unit mount 65 is fixed to an end of the guide rails 60 and is operable to support the saw unit 20 about the chop axis 25. The saw unit 20 is also movable in a direction parallel to the bevel axis 55 via the guide rails 60 slidably coupled to the bevel arm 50. In other embodiments, the guide rails 60 can be omitted such that the saw unit 20 cannot slide in a direction parallel to the bevel axis 55 (e.g., the saw unit mount 65 is a portion of the bevel arm 50).

With continued reference to FIGS. 1 and 2, the saw unit 20 includes a housing 70 (e.g., a saw arm) that is coupled to the saw unit mount 65 about the chop axis 25. The illustrated housing 70 supports a saw blade 75 and a motor 80 operable to drive the saw blade 75 about a saw blade axis 85. In the illustrated embodiment, the saw blade 75 includes a diameter D (FIG. 6) between about 7 inches and about 8 inches (e.g., 7.25 inches). In other embodiments, the diameter D of the saw blade 75 can be smaller than about 7 inches, about 10 inches, about 12 inches, etc. The housing 70 includes an upper blade guard 90 that covers an upper portion of the saw blade 75 and a lower blade guard 95 pivotably coupled to the upper blade guard 90 about a guard axis 100 (FIG. 3) to selectively cover a lower portion of the saw blade 75. Specifically, the lower blade guard 95 is biased in a first rotational direction to cover the lower portion of the saw blade 75. In other embodiments, the miter saw 10 can include one of the upper blade guard 90 and the lower blade guard 95. The illustrated housing 70 also includes a handle 110 operable to move the saw unit 20 about the chop axis 25. The handle 110 includes a trigger operable to actuate the motor 80 to drive the saw blade 75 about the saw blade axis 85.

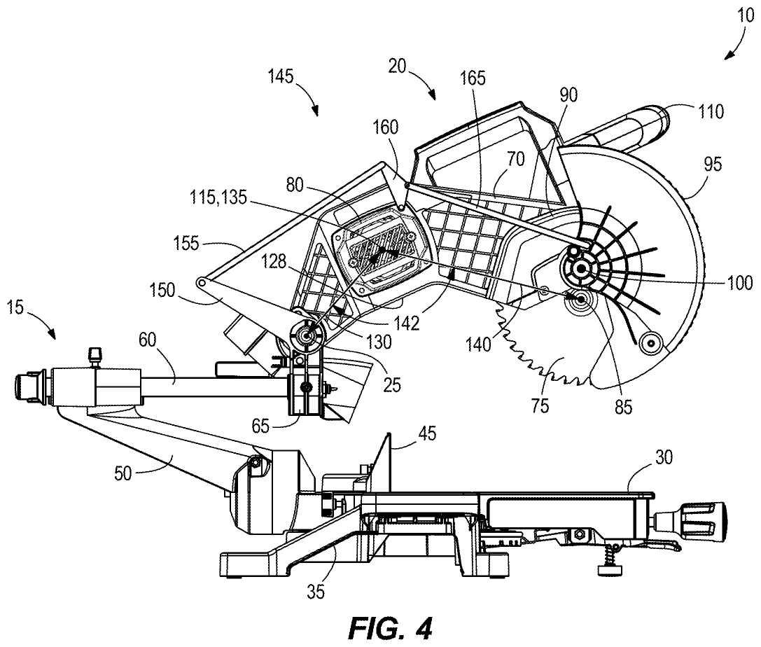

As shown in FIG. 3, the housing 70 includes a bent line 105 extending through the chop axis 25, a drive axis 115 of the motor 80, and the guard axis 100. In other embodiments, the bent line 105 can extend through the chop axis 25, the drive axis 115, and the saw blade axis 85. Stated another way, a first reference plane includes the chop axis 25 and the drive axis 115, and a second reference plane includes the drive axis 115 and the guard axis 100/saw blade axis 85. The drive axis 115 is defined by a drive shaft of the motor 80. In the illustrated embodiment, the drive axis 115 is parallel to the saw blade axis 85 and the guard axis 100. In other embodiments, the drive axis 115 can be obliquely oriented relative to the saw blade axis 85 and the guard axis 100. With reference back to FIG. 2, a drive belt 118 is positioned within the housing 70 to couple the saw blade 75 and the motor 80 for the motor 80 to drive the saw blade 75. In particular, the drive belt 118 is positioned on one lateral side of the housing 70 (FIG. 2) and the motor 80 is positioned on the other lateral side of the housing 70 (FIG. 3). In addition, the illustrated motor 80 is positioned relative to the housing 70 such that the entire motor 80 is positioned above a line 120 (FIG. 3), which intersects the guard axis 100 (or the saw blade axis 85) and the chop axis 25. Also, a portion of the line 120 (e.g., below the motor 80) does not intersect a portion of the housing 70 such that a void 125 is formed between the line 120 and a lower surface 128 the housing 70 in the reference frame of FIG. 3 (e.g., a side view of the miter saw 10). Furthermore, the motor 80 is positioned radially closer to the chop axis 25 than the saw blade axis 85. With reference to FIG. 4, a first distance 130 measured between the chop axis 25 and a location 135 on the motor 80 (e.g., a point on the drive axis 115) is shorter than a second distance 140 measured between the saw blade axis 85 and the same location 135 on the motor 80. In other embodiments, the location 135 can be positioned elsewhere on the motor 80. In the illustrated embodiment, a ratio of the first distance 130 to the second distance 140 is between about 0.3 and about 0.7 (e.g., the ratio is about 0.5). In other embodiments, the ratio of the first distance 130 to the second distance 140 can be between about 0.1 and about 0.3 or the ratio can be between about 0.7 and about 1.0. Furthermore, the first distance 130 is oriented at an oblique angle 142 relative to the second distance 140. In other words, the oblique angle 142 defines the reference planes of the bent line 105. The illustrated oblique angle 142 is between about 110 degrees and about 130 degrees (e.g., about 120 degrees). In other embodiments, the oblique angle 142 can be between about 100 degrees and about 110 degrees, or the oblique angle 142 can be between about 130 degrees and about 140 degrees.

With reference back to FIG. 3, the miter saw 10 also includes a blade guard linkage 145 coupled between the saw unit mount 65 and the lower blade guard 95. The illustrated blade guard linkage 145 includes an extension arm 150, a first fixed length linkage 155, a pivot guide 160, and a second fixed length linkage 165. The extension arm 150 is fixed to the saw unit mount 65 and the guide 160 is pivotably coupled to the housing 70. In some embodiments, the guide 160 can be pivotably coupled to the motor 80. The illustrated first linkage 155 is pivotably coupled to the extension arm 150 and the guide 160, and the second linkage 165 is pivotably coupled to lower blade guard 95 and the guide 160. The pivot point of the guide 160 relative to the housing 70 is spaced from the connection point of the first linkage 155 and the guide 160, which is also spaced from the connection point of the second linkage 165 and the guide 160.

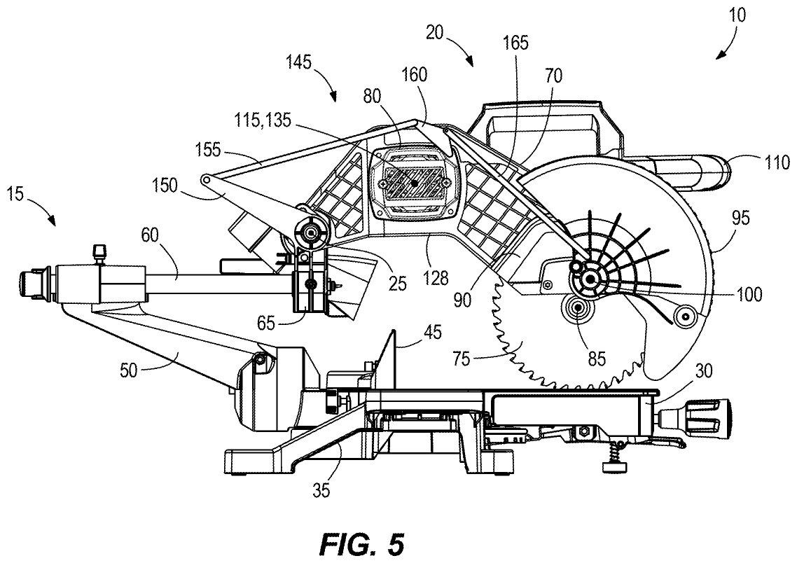

With reference to FIGS. 3-5, as the saw unit 20 is moved from a raised position (FIG. 3) toward a lowered position (FIG. 5), the blade guard linkage 145 automatically retracts the lower blade guard 95 and exposes the saw blade 75. In particular, the lower blade guard 95 rotates about the guard axis 100 in response to movement of the guide 160 relative to the housing 70. The guide 160 pivots relative to the housing 70 due to the first linkage 155 being coupled to the fixed extension arm 150, which in turn, moves the second linkage 165 to rotate the lower blade guard 95 about the guard axis 100. As the saw unit 20 is moved back to the raised position (FIG. 3), the biasing force of the lower blade guard 95 rotates the lower blade guard 95 to cover the saw blade 75. In turn, the guide 160 pivots in an opposite direction.

In operation of the miter saw 10 (FIG. 6), the workpiece 48 (e.g., a piece of crown molding) may be oriented at an incline relative to the turntable 30 (e.g., as the crown molding 48 abuts the base 35 and/or the turntable 30 to stand on its spring angle). In some embodiments, the crown molding 48 includes a width W sized such that a moveable fence 168 of the fence assembly 45 can support an upper portion 169 of the crown molding 48. The illustrated housing 70 is configured to provide additional clearance to the crown molding 48 such that the housing 70 does not interfere with the crown molding 48 during a cutting operation. In particular, as the saw unit 20 slides rearwardly along the bevel axis 55 to perform a cutting operation on the crown molding 48 (FIG. 6), the upper portion 169 of the crown molding 48 moves into position within the void 125 (e.g., above the line 120) as to not interfere with the housing 70. With continued movement of the saw unit 20 in the rearward direction, the saw unit 20 continues to cut the workpiece 48 until the crown molding 48 abuts the lower surface 128 of the housing 70 potentially leaving a small portion of the crown molding 48 left uncut. The saw unit 20 is then rotated upwardly about the chop axis 25 to complete the cutting operation on the crown molding 48.

The illustrated configuration of the housing 70 allows for the relatively small saw blade 75 to cut relatively wide workpieces. For example, the housing 70 is configured as to not impede a cutting operation of the miter saw 10 on the workpiece 48 when a ratio of the width W of the workpiece 48 and the diameter D of the saw blade 75 is be between 1.1 and 0.8. In other embodiments, the ratio of the width W of the workpiece 48 and the diameter D of the saw blade 75 can be any range between 1.5 and 0.5. In addition, a ratio of the diameter D of the saw blade 75 and a distance between the chop axis 25 and the saw blade axis 85 (along line 120) is between about 0.5 and about 0.7 (e.g., 0.6). In other embodiments, the ratio of the diameter D of the saw blade 75 and the distance between the chop axis 25 and the saw blade axis 85 can be any range between 0.5 and 0.7.

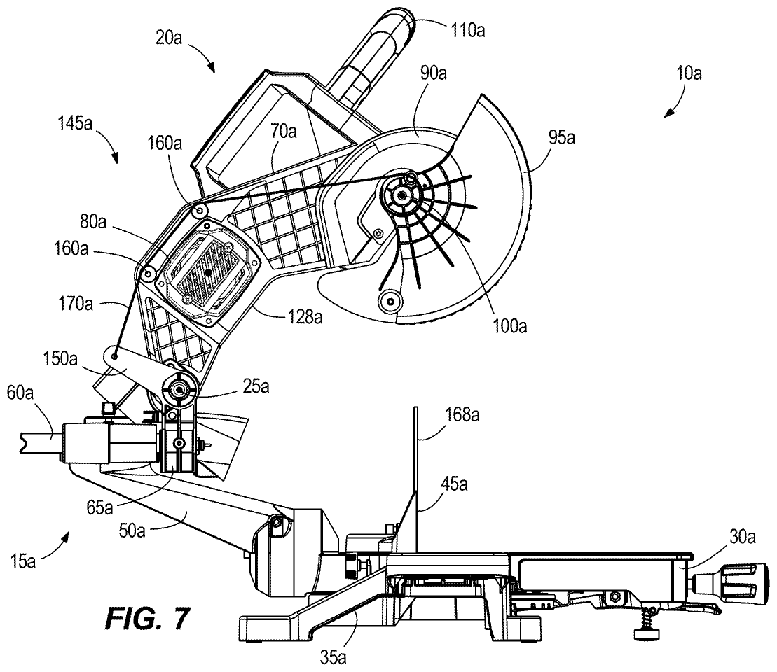

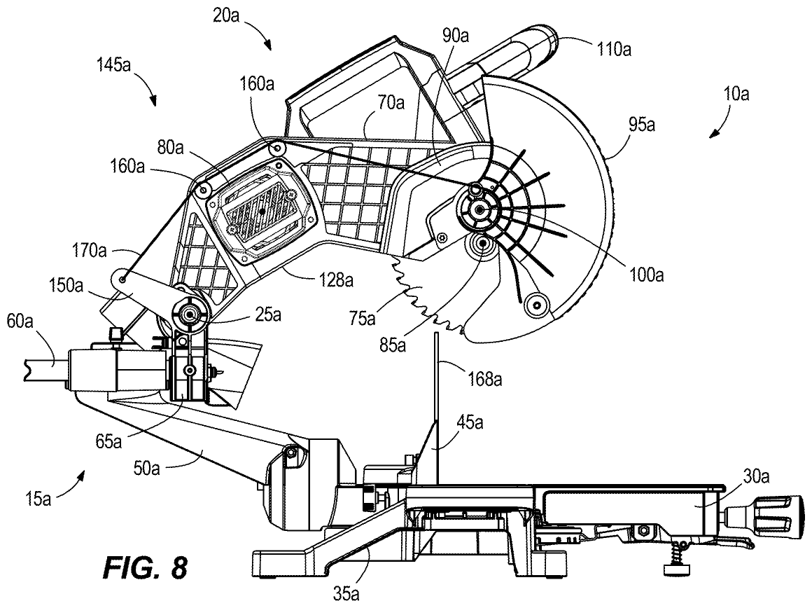

FIGS. 7-9 illustrate a miter saw 10a according to another embodiment. The miter saw 10a is similar to the miter saw 10. Therefore, similar components are designated with similar references numbers with the addition to the letter “a.” At least some differences and/or at least some similarities between the miter saws 10, 10a will be discussed in detail below. In addition, components or features described with respect to the miter saw 10a are equally applicable to any other embodiments described herein.

The miter saw 10a includes a base assembly 15a and a saw unit 20a pivotably coupled to the base assembly 15a about a first or chop axis 25a. The illustrated base assembly 15a includes a turntable 30a pivotably coupled to a base 35a of the base assembly 15a. The base 35a includes a fence assembly 45a having a moveable fence 168a. A bevel arm 50a is pivotably coupled to the turntable 30a, and guide rails 60a are slidably coupled to the bevel arm 50a. In addition, a saw unit mount 65a is fixed to ends of the guide rails 60a. The saw unit 20a includes a housing 70a and supports a saw blade 75a and a motor 80a operable to drive the saw blade 75a about a saw blade axis 85a. The housing 70a includes an upper blade guard 90a and a lower blade guard 95a pivotably coupled to the upper blade guard 90a about a guard axis 100a. The housing 70a also includes a handle 110a.

In addition, the miter saw 10a includes a blade guard linkage 145a having a flexible member 170a (e.g., rope, cable, etc.) with a first end coupled to an extension arm 150a and a second end coupled to the lower blade guard 95a. At least one guide 160a (two guides 160a are shown in FIGS. 7-9) directs the flexible member 170a in a desired path relative to the housing 70a (e.g., above the motor 80a). In some embodiments, the guides 160a can be fixed posts, rollers, etc. In other embodiments, the guides 160a can direct the flexible member 170a along a different desired path relative to the housing 70a (e.g. below the motor 80a).

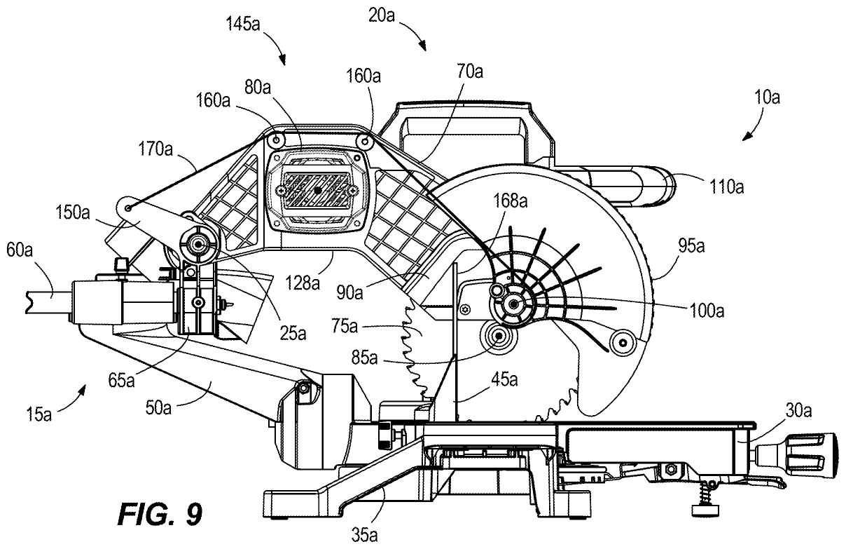

When the saw unit 20a is in the raised position (FIG. 7), the flexible member 170a at least partially extends around the guard axis 100a. As the saw unit 20a is moved toward the lowered position (FIG. 9), the flexible member 170a acts against the biasing force of the lower blade guard 95a to rotate the lower blade guard 95a about the guard axis 100a to expose the saw blade 75a, partially unwrapping the flexible member 170a about the guard axis 100a. In the illustrated embodiment, the flexible member 170a is still at least partially wrapped around the guard axis 100a when the saw unit 20a is in the lowered position. As the saw unit 20a is moved back to the raised position (FIG. 7), the biasing force of the lower blade guard 95a rotates the lower blade guard 95a to cover the saw blade 75a, again wrapping the flexible member 170a about the guard axis 100a.

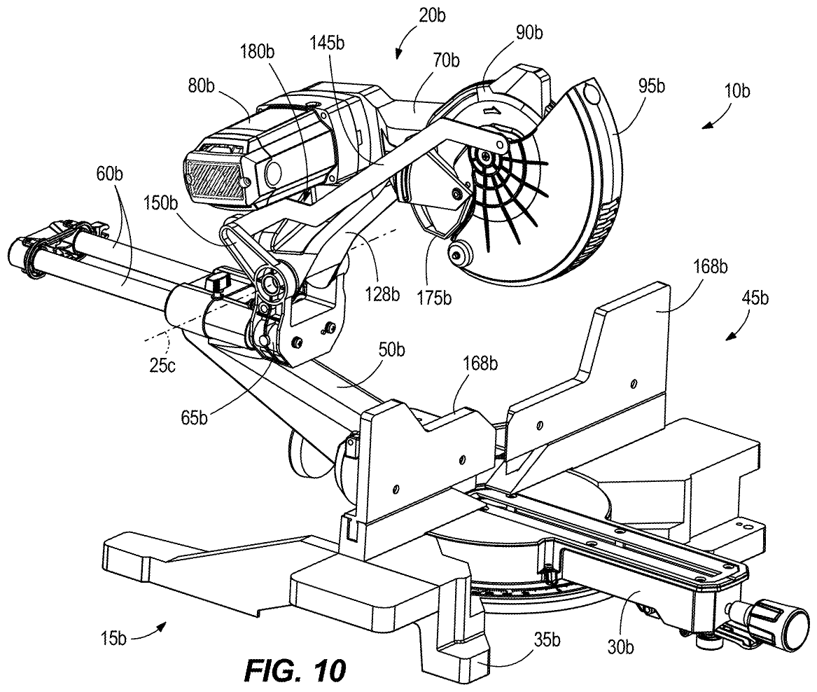

FIGS. 10-13 illustrate a miter saw 10b according to another embodiment. The miter saw 10b is similar to the miter saws 10, 10a. Therefore, similar components are designated with similar references numbers with the addition to the letter “b.” At least some differences and/or at least some similarities between the miter saws 10, 10a, 10b will be discussed in detail below. In addition, components or features described with respect to the miter saw 10b are equally applicable to any other embodiments described herein.

The miter saw 10b includes a base assembly 15b and a saw unit 20b pivotably coupled to the base assembly 15b about a first or chop axis 25b. The illustrated base assembly 15b includes a turntable 30b pivotably coupled to a base 35b. The base 35b includes a fence assembly 45b having moveable fences 168b. A bevel arm 50b is pivotably coupled to the turntable 30b, and guide rails 60b are slidably coupled to the bevel arm 50b. In addition, a saw unit mount 65b is fixed to an end of the guide rails 60b. The saw unit 20b includes a housing 70b that supports a saw blade 75b and a motor 80b. The housing 70b includes an upper blade guard 90b and a lower blade guard 95b pivotably coupled to the upper blade guard 90b about a guard axis 100b. The saw unit 20b also includes a moveable guard 175b pivotably coupled to the upper blade guard 90b. The moveable blade guard 175b includes a slot that receives a portion of the saw blade 75b. The moveable guard 175b is biased in a direction opposite the lower blade guard 95b such that the lower blade guard 95b and the moveable guard 175b are operable to cover a portion of the saw blade 75b extending beyond the upper blade guard 90b when the saw unit 20b is in a raised position (FIG. 10).

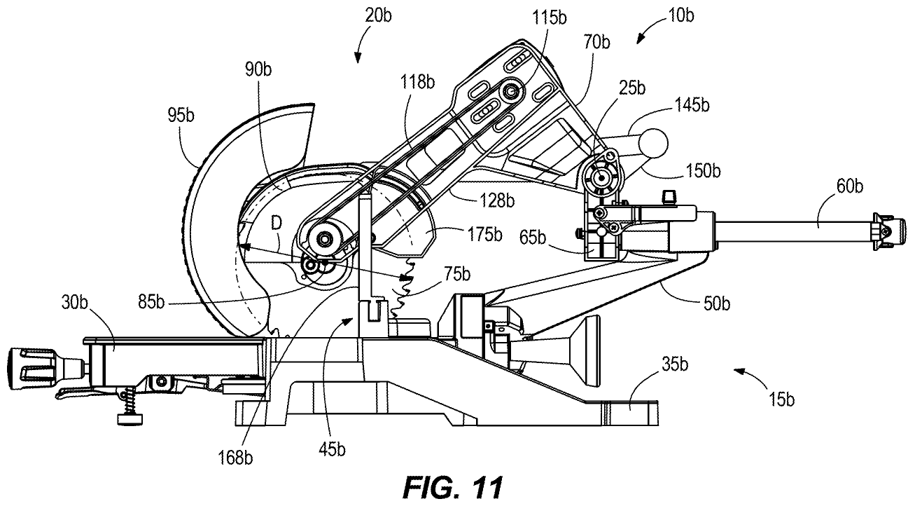

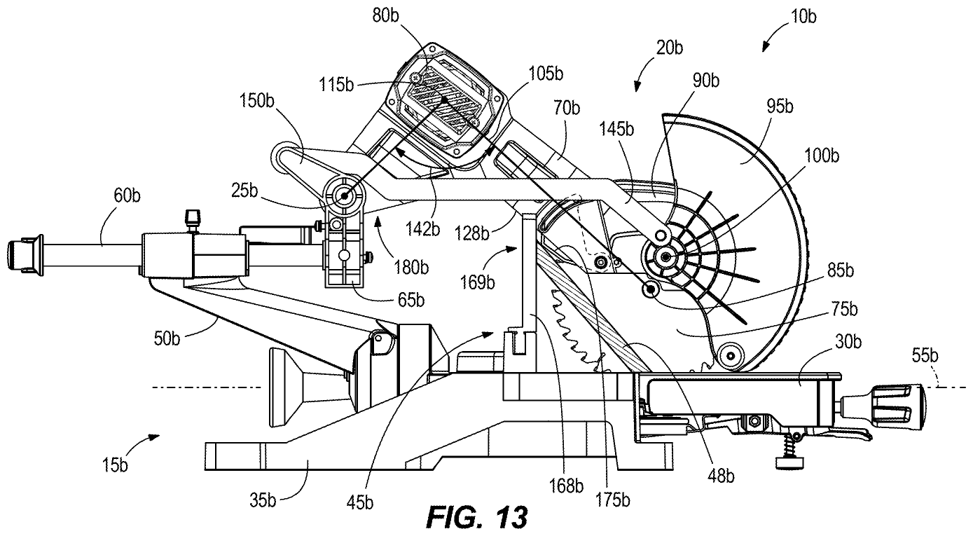

With reference to FIG. 11, a drive belt 118b is positioned within the housing 70b to couple the saw blade 75b and the motor 80b for the motor 80b to drive the saw blade 75b about a saw blade axis 85b. As shown in FIG. 13, a bent line 105b of the housing 70b extends between the chop axis 25b, a drive axis 115b of the motor 80b, and the saw blade axis 85b to define an angle 142b. In the illustrated embodiment, the angle 142b is between about 85 degrees and about 105 degrees (e.g., about 95 degrees). In other embodiments, the angle 142b can be less than 85 degrees or greater than 105 degrees. For example, the angle 142b can be between about 60 degrees and about 85 degrees, or the angle 142b can be between about 105 degrees and about 130 degrees. In further embodiments, the angle 142b can be between about 85 degrees and about 130 degrees.

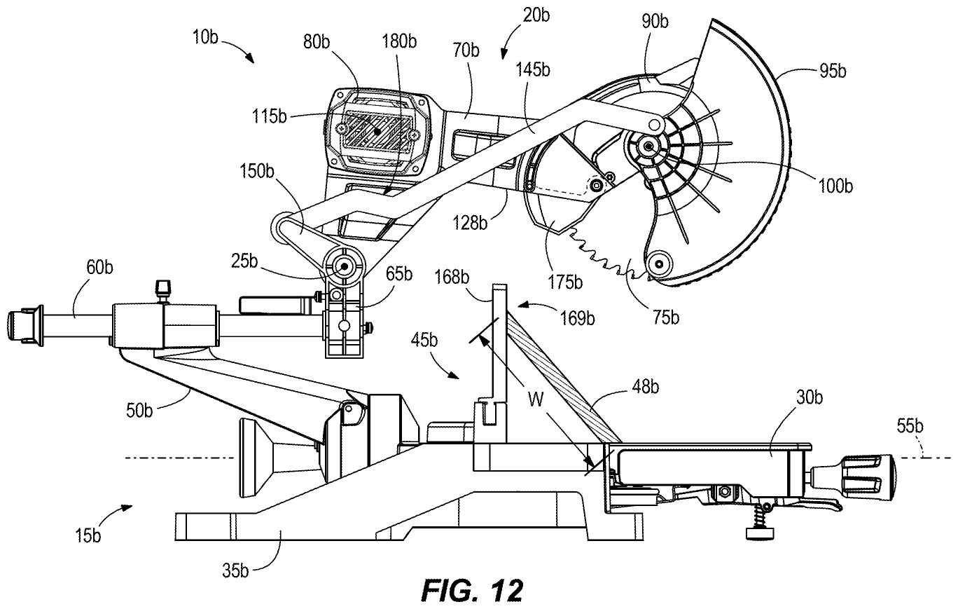

With reference to FIGS. 12 and 13, the miter saw 10b also includes a fixed length blade guard linkage 145b with a first end coupled to an extension arm 150b and a second end coupled to the lower blade guard 95b. The illustrated blade guard linkage 145b is positioned on the same side as the motor 80b such that the motor 80b laterally extends beyond the blade guard linkage 145b. As such, the blade guard linkage 145b is always positioned below the motor 80b. For example, the blade guard linkage 145b is positioned below the motor 80b when the saw unit 20b moves between a raised position (FIG. 10) and a lowered position (FIG. 13). With reference to FIG. 12, the blade guard linkage 145b includes a notch 180b (e.g., a bend) that interfaces with the motor 80b when the saw unit 20b is in the raised position to avoid the motor 80b interfering with the movement of the blade guard linkage 145b. The notch 180b also provides enough clearance between the extension arm 150b and the blade guard linkage 145b when the saw unit 20b is in the lowered position (FIG. 13).

In operation of the miter saw 10b (FIGS. 12 and 13), a width W of a workpiece 48b can be supported between the moveable fence 168b of the fence assembly 45b and the base 35b and/or the turntable 30b when the crown molding 48b stands on its spring angle. As the saw unit 20b slides rearwardly along a bevel axis 55b to perform a cutting operation on the crown molding 48b (FIG. 13), an upper portion 169b of the crown molding 48b engages the moveable guard 175b to pivot the moveable guard 175b into the upper blade guard 90b allowing for additional clearance for the saw unit 20b to cut the workpiece 48b. With continued movement of the saw unit 20b in the rearward direction, the crown molding 48b can abut a lower surface 128b of the housing 70b and the saw unit 20b is rotated upwardly about the chop axis 25b to complete the cutting operation on the crown molding 48b.

Again, the illustrated configuration of the housing 70b allows for the relatively small saw blade 75b to cut relatively wide workpieces. For example, a ratio of a diameter D of the saw blade 75b (FIG. 11) and a distance between the chop axis 25b and the saw blade axis 85b is between about 0.4 and about 0.6 (e.g., 0.5). In other embodiments, the ratio of the diameter D of the saw blade 75b and the distance between the chop axis 25b and the saw blade axis 85b can be between about 0.4 and about 0.7.

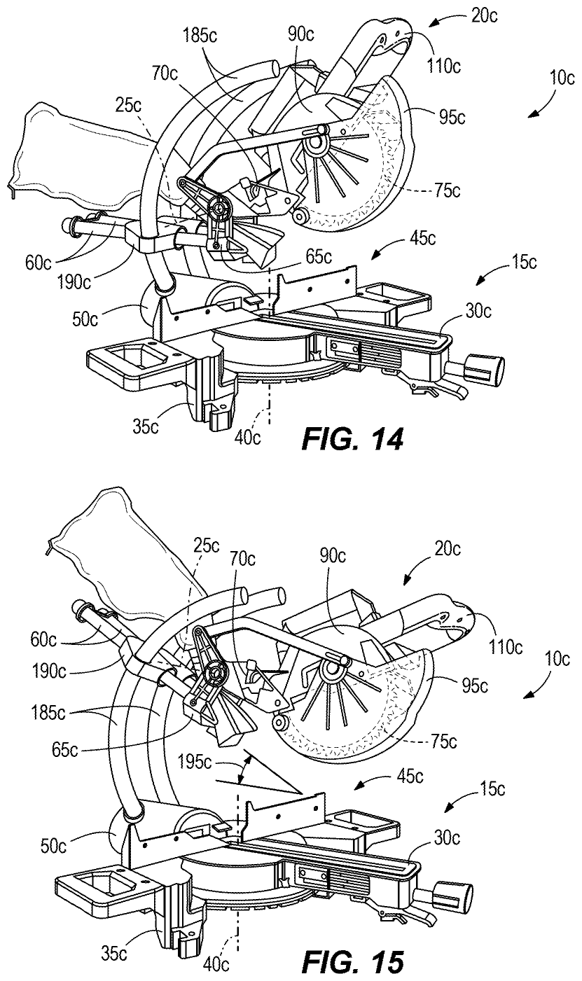

FIGS. 14-16 illustrate a miter saw 10c according to another embodiment. The miter saw 10c is similar to the miter saws 10, 10a, 10b. Therefore, similar components are designated with similar references numbers with the addition to the letter “c.” At least some differences and/or at least some similarities between the miter saws 10, 10a, 10b, 10c will be discussed in detail below. In addition, components or features described with respect to the miter saw 10c are equally applicable to any other embodiments described herein.

The miter saw 10c includes a base assembly 15c and a saw unit 20c pivotably coupled to the base assembly 15c about a first or chop axis 25c. The illustrated base assembly 15c includes a turntable 30c pivotably coupled to a base 35c about a miter axis 40c. The base 35c includes a fence assembly 45c. A bevel arm 50c is pivotably coupled to the turntable 30c and includes two arcuate support rails 185c. In other embodiments, the bevel arm 50c can include at least one arcuate support member 185c. The illustrated support rails 185c slidably support a mount 190c along a length of the support rails 185c, and the mount 190c slidably supports guide rails 60c in a direction transverse to the length of the support rails 185c. In particular, the mount 190c is movable along the length of the support rails 185c, thereby permitting adjustment of the inclination of the guide rails 60c relative to the turntable 30c. The mount 190c includes a locking mechanism (not shown) configured to selectively lock the mount 190c to the bevel arm 50c once a desired position of the mount 190c along the bevel arm 50c is determined. To reposition the mount 190c relative to the bevel arm 50c, the user needs only to release the locking mechanism, reposition the mount 190c on the bevel arm 50c, and re-engage the locking mechanism to secure the mount 190c to the bevel arm 50c.

In addition, a saw unit mount 65c is fixed to ends of the guide rails 60c. The saw unit 20c includes a housing 70c that supports a saw blade 75c and a motor. The housing 70c includes an upper blade guard 90c and a lower blade guard 95c pivotably coupled to the upper blade guard 90c. The housing 70c also includes a handle 110c.

With reference to FIG. 14, the mount 190c can be positioned on the bevel arm 50c such that the guide rails 60c are bisected by a horizontal plane (not shown) that is also perpendicular to the miter axis 40c (e.g., the guide rails 60c are parallel to a bevel axis of the base assembly 15c). When the mount 190c is moved relative to the bevel arm 50c to the position shown in FIG. 15, the plane bisecting the guide rails 60c is inclined by an oblique angle 195c relative to the miter axis 40c and the turntable 30c (e.g., the guide rails 60c are obliquely oriented relative to the bevel axis of the base assembly 15c). As such, the miter saw 10c is configured as a “multi-plane” miter saw 10c in which the guide rails 60c, and thus the saw unit 20c, can be adjusted to different inclination angles 195c between the orientations at least shown in FIGS. 14 and 15.

In other embodiments, the bevel arm 50c can be differently configured, or the miter saw 10c can further include an intermediate linkage mechanism, pivot mechanism, and/or the like, between the bevel arm 50c and the mount 190c to adjust the orientation of the guide rails 60c relative to the turntable 30c. In this way, the orientation of the saw blade 75c can be set to any one plane selected from a plurality of multiple, different planes. Furthermore, in other embodiments of the miter saw 10c, the guide rails 60c may be omitted and the saw unit 20c may be pivotably coupled directly to the mount 190c (e.g., the saw unit mount 65c forms the mount 190c), thereby making the miter saw 10c a non-sliding compound miter saw.

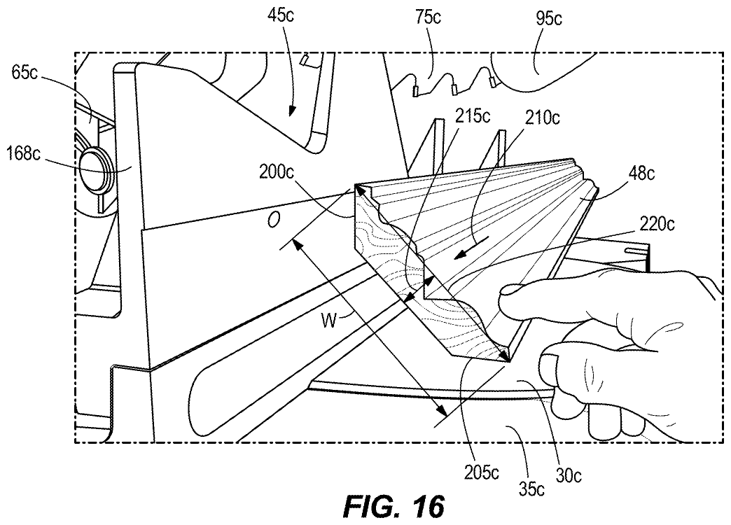

In operation of the miter saw 10c, a workpiece (e.g., a piece of crown molding 48c) may be oriented on its spring angle relative to the turntable 30c (e.g., by 45 degrees, like shown in FIG. 16), such that a first interior edge 200c of the crown molding 48c lays flat against the fence assembly 45b (e.g., against a moveable fence 168c) and a second interior edge 205c of the crown molding 48c lays flat against the turntable 30c. With the piece of crown molding 48c oriented in this manner, the position of the mount 190c relative bevel arm 50c is adjusted as described above so that the guide rails 60c are oriented at about the same inclination angle 195c (relative to the turntable 30c) as the piece of crown molding 48c (e.g., 45 degrees, as shown in FIG. 16) relative to the turntable 30c. In this manner, the saw unit 20c can plunge into the piece of crown molding 48c in a direction 210c that is generally parallel to a thickness 215c of the crown molding 48c (FIG. 16). And, the guide rails 60c are slidable relative to the mount 190c to slide the saw unit 20c in a transverse direction 220c (FIG. 16) to cut along a width W of the crown molding 48c to sever the crown molding 48c into two pieces. Because the saw blade 75c plunges into the piece of crown molding 48c along the thickness 215c of the crown molding 48c, and is then slidable relative to the crown molding 48c along the width W, a radius of the saw blade 75c needs only to be nominally greater than the width W of the crown molding 48c. As such, a relatively small diameter (e.g., 7 inches) saw blade 75c can be used to cut through a relatively tall (e.g., 5 inches) piece of crown molding 48c. In this way, a user may employ a smaller, more easily portable miter saw 10c to cut crown molding 48c at a jobsite, the user's cuts may be more precise without having to miter and bevel, and the cutting of crown molding 48c becomes more efficient, as the user may forego having to compute various cutting angles.

Although the disclosure has been described in detail with reference to certain preferred embodiments, variations and modifications exist within the scope and spirit of one or more independent aspects of the disclosure as described. Various features and advantages of the disclosure are set forth in the following claims.

1. A miter saw comprising:
a base assembly; and
a saw unit pivotably coupled to the base assembly about a first axis, the saw unit including
a saw arm,
a motor supported by the saw arm, and
a saw blade supported by the saw arm, the saw blade driven by the motor to rotate about a second axis, the saw blade including a diameter,
wherein a ratio of the diameter of the saw blade to a distance between the first and second axes is between 0.4 and 0.7.

2. The miter saw of claim 1, wherein a first line extends between the first and second axes such that a void is formed between the first line and a bottom surface of the saw arm, and wherein the saw arm is configured such that a portion of a workpiece is positionable within the void during a cutting operation of the miter saw.

3. The miter saw of claim 2, wherein the motor is rotatable about a drive axis to drive the saw blade, wherein a first reference plane includes the first axis and the drive axis, wherein a second reference plane includes the drive axis and the second axis, and wherein an angle between the first and second reference planes is between 85 degrees and 130 degrees.

4. The miter saw of claim 1, wherein the motor is positioned closer to the first axis than the second axis.

5. The miter saw of claim 4, wherein the motor is rotatable about a drive axis to drive the saw blade, and wherein the drive axis is parallel with the second axis.

6. The miter saw of claim 1, wherein the motor is operable to drive the saw blade via a drive belt.

7. The miter saw of claim 1, wherein the saw unit includes an upper blade guard and a lower blade guard pivotably coupled to the upper blade guard, wherein the miter saw further comprises a blade guard linkage configured to pivot the lower blade guard relative to the upper blade guard as the saw unit is lowered toward the base assembly.

8. The miter saw of claim 7, wherein the blade guard linkage includes
a guide supported by the saw arm,
a first linkage pivotably coupled to the base assembly and the guide, and
a second linkage pivotably coupled to the guide and the lower blade guard, and wherein the second linkage is operable to pivot the lower blade guard relative to the upper blade guard in response to the first linkage pivoting the guide relative to the saw arm.

9. The miter saw of claim 7, wherein the blade guard linkage includes a flexible member having a first end coupled to the base assembly, a second end coupled to the lower blade guard, and a middle portion guided relative to the saw arm such that the flexible member is operable to pivot the lower blade guard relative to the upper blade guard in response to the saw unit being lowered toward the base assembly.

10. A miter saw comprising:
a base assembly; and
a saw unit pivotably coupled to the base assembly about a first axis, the saw unit including
a saw arm,
a motor supported by the saw arm, and
a saw blade supported by the saw arm, the saw blade driven by the motor to rotate about a second axis,
wherein a line extends between the first and second axes such that a void is formed between the line and a bottom surface of the saw arm, and wherein the saw arm is configured such that a portion of a workpiece supported on the base assembly is positionable within the void during a cutting operation of the miter saw.

11. The miter saw of claim 10, wherein the motor is positioned closer to the first axis than the second axis.

12. The miter saw of claim 11, wherein the motor is rotatable about a drive axis to drive the saw blade, wherein a first reference plane includes the first axis and the drive axis, wherein a second reference plane includes the drive axis and the second axis, and wherein an angle between the first and second reference planes is between 85 degrees and 130 degrees.

13. The miter saw of claim 11, wherein the motor is rotatable about a drive axis to drive the saw blade, and wherein the drive axis is parallel with the second axis.

14. The miter saw of claim 10, wherein the motor is operable to drive the saw blade via a drive belt.

15. The miter saw of claim 10, wherein the saw unit includes a first blade guard pivotably coupled to the saw arm, wherein the saw unit includes a blade guard linkage coupled to the base assembly and the first blade guard, and wherein the blade guard linkage is configured to pivot the first blade guard relative to the saw arm as the saw unit is lowered toward the base assembly.

16. The miter saw of claim 15, wherein the saw arm includes a second blade guard, and wherein the first blade guard is pivotably coupled to the second blade guard.

17. The miter saw of claim 16, wherein the blade guard linkage includes
a guide supported by the saw arm,
a first linkage pivotably coupled to the base assembly and the guide, and
a second linkage pivotably coupled to the guide and the first blade guard, and wherein the second linkage is operable to pivot the first blade guard relative to the second blade guard in response to the first linkage pivoting the guide relative to the saw arm.

18. The miter saw of claim 16, wherein the blade guard linkage includes a flexible member having a first end coupled to the base assembly, a second end coupled to the first blade guard, and a middle portion guided relative to the saw arm such that the flexible member is operable to pivot the first blade guard relative to the second blade guard in response to the saw unit being lowered toward the base assembly.

19. A miter saw comprising:
a base assembly including
a turntable,
a bevel arm pivotably coupled to the turntable about a bevel axis, and
a mount moveably coupled to the bevel arm between a first position, in which the mount is oriented parallel with the bevel axis, and a second position, in which the mount is oriented non-parallel with the bevel axis; and
a saw unit including
a saw arm coupled to the bevel arm via the mount,
a motor supported by the saw arm, and
a saw blade supported by the saw arm, the saw blade driven by the motor.

20. The miter saw of claim 19, wherein the base assembly includes a guide rail slidably coupled to the mount, wherein the saw arm is coupled to the mount via the guide rail, and wherein the guide rail is oriented parallel with the bevel axis when the mount is in the first position and is oriented non-parallel with the bevel axis when the mount is in the second position.

21. The miter saw of claim 19, wherein the bevel arm includes an arcuate support rail, and wherein the mount is slidably coupled to the arcuate support rail between the first and second positions.
